(19) United States
(12) Patent Application Publication
(10) Pub. No.: US 2012/0126656 A1
(43) Pub. Date: May 24, 2012

(54) ROTOR ASSEMBLY AND METHOD OF MANUFACTURING A ROTOR ASSEMBLY

(75) Inventors: Dale A. Gerard, Bloomfield Hills, MI (US); Qigui Wang, Rochester Hills, MI (US)

(73) Assignee: GM GLOBAL TECHNOLOGY OPERATIONS, INC., Detroit, MI (US)

(21) Appl. No.: 12/954,080

(22) Filed: Nov. 24, 2010

(51) Int. Cl. H02K 17/16; H01R 43/00

(52) U.S. Cl. 310/211; 29/598

(57) ABSTRACT

A rotor assembly for an electric device includes a laminated stack of electric steel sheets defining a plurality of longitudinally extending grooves. A conductor bar is disposed within each of the grooves. Each of the conductor bars includes a first end and a second end extending longitudinal outward from opposing axial end surfaces of the laminated stack. The first end and the second end of the conductor bars include a macro-sized locking feature. A first end ring is cast in place over the first ends of the conductor bars, and a second end ring is cast in place over the second ends of the conductor bars. The macro-sized locking feature in the first ends and the second ends of the conductor bars mechanically interlocks with the cast in place first end ring and second end ring respectively.

### TECHNICAL FIELD

The invention generally relates to a rotor assembly for an electric device, and to a method of manufacturing the rotor assembly.

### BACKGROUND

Rotor assemblies for an electric device, including but not limited to an induction electric motor, typically include a stack of laminated electric steel sheets that support a plurality of conductor bars disposed within longitudinal grooves defined by the laminated stack of electric steel sheets. The conductor bars extend outward beyond axial end surfaces of the laminated stack of electric steel sheets. The rotor assembly includes a first end ring and a second end ring disposed at the opposite axial end surfaces of the laminated stack of electric steel sheets. The first end ring and the second end ring electrically connect the ends of the conductor bars at the respective axial end surfaces of the laminated stack of electric steel sheets. The end rings and the conductor bars may be simultaneously cast in place. Alternatively, the first end ring and the second end ring may be cast in place from aluminum over the ends of pre-molded conductor bars that are positioned in the longitudinal groove of the laminated stack.

### SUMMARY

A rotor assembly for an electric device is provided. The rotor assembly includes a plurality of laminated electric steel sheets. Each of the plurality of electric steel sheets defines a plurality of slots. The plurality of slots is disposed angularly about and equidistant from a central axis. The plurality of laminated electric steel sheets is disposed adjacent each other to define a laminated stack having a first end surface and a second end surface. The second end surface is spaced from the first end surface along the central axis. The plurality of slots is aligned to define a plurality of longitudinal grooves in the laminated stack. The rotor assembly further includes a plurality of conductor bars. One of the plurality of conductor bars is disposed within each of the plurality of longitudinal grooves. Each of the plurality of conductor bars includes a first end. The first end extends axially beyond the first end surface of the laminated stack along the central axis. A first end ring is disposed against and abuts the first end surface. The first end ring at least partially surrounds and electrically connects the first end of each of the plurality of conductor bars. The first end of each of the plurality of conductor bars includes a macro-sized locking feature that mechanically interlocks with the first end ring.

A rotor assembly for an electric device is also provided. The rotor assembly includes a plurality of laminated electric steel sheets. Each of the plurality of electric steel sheets defines a plurality of slots. The plurality of slots is disposed angularly about and equidistant from a central axis. The plurality of laminated electric steel sheets is disposed adjacent each other to define a laminated stack. The laminated stack includes a first end surface and a second end surface. The second end surface is spaced from the first end surface along the central axis. The plurality of slots is aligned to define a plurality of longitudinal grooves in the laminated stack that extend along the central axis. The rotor assembly further includes a plurality of conductor bars. One of the plurality of conductor bars is disposed within each of the plurality of longitudinal grooves. Each of the plurality of conductor bars includes a first end and a second end. The first end extends axially beyond the first end surface of the laminated stack along the central axis. The second end extends axially beyond the second end surface of the laminated stock along the central axis. A first end ring is disposed against and abuts the first end surface. The first end ring at least partially surrounds and electrically connects the first end of each of the plurality of conductor bars. A second end ring is disposed against and abuts the second end surface. The second end ring at least partially surrounds and electrically connects the second end of each of the plurality of conductor bars. The first end and the second end of each of the plurality of conductor bars include a macro-sized locking feature that mechanically interlocks with the first end ring and the second end ring respectively. The first end ring and the second end ring are cast in place from aluminum over the first ends and the second ends of the plurality of conductor bars respectively. The macro-sized locking feature includes a notch extending inward into each of the plurality of conductor bars.

A method of manufacturing a rotor assembly for an electric device is also provided. The method includes molding a plurality of conductor bars to define a macro-sized locking feature in a first end and a second end of each of the plurality of conductor bars. The method further includes laminating a plurality of electric steel sheets to define a laminated stack. The laminated stack includes a first end surface and a second end surface axially spaced from the first end surface along a central axis, and a plurality of longitudinal grooves extending along the central axis between the first end surface and the second end surface. The plurality of grooves is angularly spaced about and equidistant from the central axis. The method further includes positioning one of the plurality of conductor bars in each of the plurality of longitudinal grooves such that the first end and the second end of each of the plurality of conductor bars extend outward beyond the first end surface and the second end surface of the laminated stack respectively. The method further includes casting a first end ring in place around the macro-sized locking feature of the first end of each of the plurality of conductor bars to at least partially surround and electrically connect the first end of each of the plurality of conductor bars.

Accordingly, the macro-sized locking feature in the first end and the second end of each of the conductor bars mechanically interlocks with the cast in place first end ring and the cast in place second end ring respectively, to provide a stronger mechanical connection therebetween and improve the electrical connection between each of the conductor bars and the first end ring and the second end ring.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic exploded perspective view of a rotor assembly.

FIG. 2 is a schematic end plan view of an electric steel sheet of the rotor assembly.

FIG. 3 is a schematic side view of a laminated stack of the electric steel sheets.

FIG. 4 is an enlarged schematic fragmentary top plan view of the rotor assembly.

FIG. 5 is a schematic cross sectional view of an end of a conductor bar showing a first alternative embodiment of a macro-sized locking feature.

FIG. 6 is a schematic cross sectional view of the end of the conductor bar showing a second alternative embodiment of the macro-sized locking feature.

FIG. 7 is a schematic cross sectional view of the end of the conductor bar showing a third alternative embodiment of the macro-sized locking feature.

FIG. 8 is a schematic cross sectional view of the end of the conductor bar showing a fourth alternative embodiment of the macro-sized locking feature.

FIG. 9 is a schematic cross sectional view of the end of the conductor bar showing a fifth alternative embodiment of the macro-sized locking feature.

FIG. 10 is a schematic cross sectional view of the end of the conductor bar showing a sixth alternative embodiment of the macro-sized locking feature.

### DETAILED DESCRIPTION

Referring to the Figures, wherein like numerals indicate like parts throughout the several views, a rotor assembly is shown generally at 20. The rotor assembly 20 is for an electric device, including but not limited to an induction electric motor. The rotor assembly 20 may commonly be referred to as a squirrel cage type rotor assembly 20.

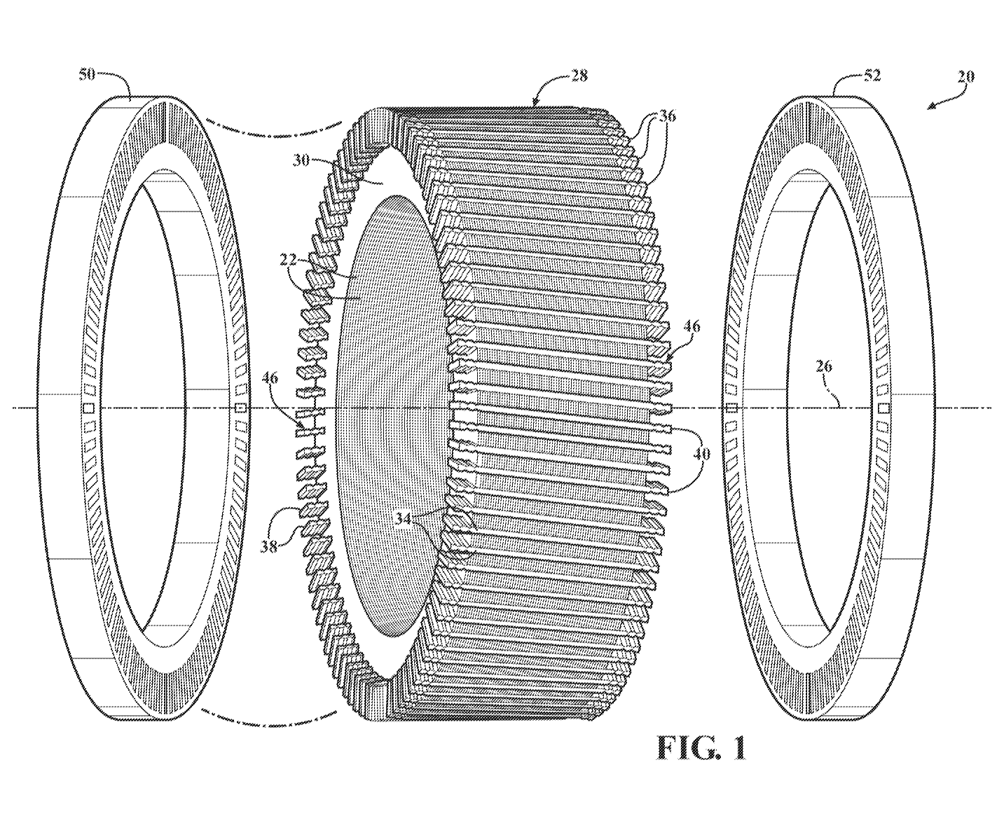

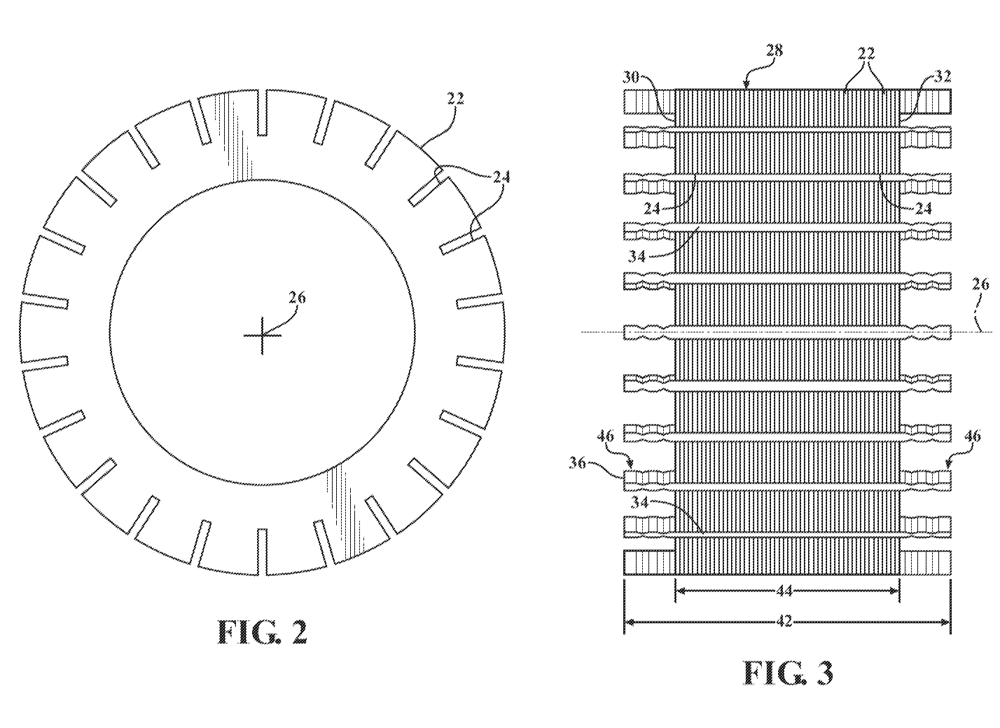

Referring to FIGS. 1 through 3, the rotor assembly 20 includes a plurality of laminated electric steel sheets 22. A single electric steel sheet 22 is shown in FIG. 2. As best shown in FIG. 2, each of the electric steel sheets 22 defines a plurality of slots 24. The slots 24 are disposed angularly about and equidistant from a central axis 26, near an outer periphery of the electric steel sheets 22. The electric steel sheets 22 are disposed adjacent each other and concentric about the central axis 26 to define a laminated stack 28 shown in FIGS. 1 and 3. Referring to FIG. 3, the laminated stack 28 includes a first end surface 30 and a second end surface 32. The second end surface 32 is spaced from the first end surface 30 along the central axis 26. The first end surface 30 and the second end surface 32 define opposing axial end surfaces of the laminated stack 28 of electric steel sheets 22. The slots 24 are aligned to define a plurality of longitudinal grooves 34 in the laminated stack 28. The longitudinal grooves 34 extend between and connect the first end surface 30 and the second end surface 32. As is known, the longitudinal grooves 34 may be skewed along a length of the laminated stack 28 of electric steel sheets 22. The electric steel sheets 22 may include and be manufactured from, but are not limited to, a low carbon iron having a high silicon content to reduce eddie current loss, and may be coated with an insulating compound to reduce circulating current that may also result in eddie current loss.

Referring to FIGS. 1 and 3, the rotor assembly 20 further includes a plurality of conductor bars 36. One of the conductor bars 36 is disposed within each of the plurality of longitudinal grooves 34. The conductor bars 36 may include and be manufactured from, but are not limited to pure aluminum, a wrought aluminum alloy, an aluminum composite, copper, a copper alloy, or some other conductive material. Each of the plurality of conductor bars 36 includes a first end 38 and a second end 40. The first end 38 extends axially beyond the first end surface 30 of the laminated stack 28 along the central axis 26. The second end 40 extends axially beyond the second end surface 32 of the laminated stack 28 along the central axis 26. Accordingly, as shown in FIG. 3, it should be appreciated that the conductor bars 36 include a conductor length 42 along the central axis 26 that is greater than a stack length 44 of the laminated stack 28 of electric steel sheets 22 along the central axis 26.

Each of the conductor bars 36 may include a uniform cross sectional shape perpendicular to the central axis 26 between the first end surface 30 and the second end surface 32 of the laminated stack 28. As shown, the uniform cross sectional shape of the conductor bars 36 between the first end surface 30 and the second end surface 32 includes a rectangular shape. However, it should be appreciated that the uniform cross sectional shape may include some other shape not shown or described herein.

The first end 38 and the second end 40 of each of the conductor bars 36 include a macro-sized locking feature 46. As used herein, the term macro-sized is defined to include any feature having dimensions at least greater than 50 μm, and preferably greater than 100 μm, and that are visible with the naked eye. The macro-sized locking feature 46 may include any suitable surface irregularity and/or deformation capable of mechanically interlocking with a cast in place end ring. For example, the macro-sized locking feature 46 may include but is not limited to a notch 48 extending inward into each of the plurality of conductor bars 36. The notch 48 may include a single notch 48, or may alternatively include a plurality of notches 48 axially spaced from each other along the central axis 26. Furthermore, the notch 48 may extend circumferentially around an outer periphery of each of the conductor bars 36, or may alternatively only extend around a portion of the outer periphery of each of the conductor bars 36. For example, if the uniform cross sectional shape of each of the conductor bars 36 includes the rectangular shape shown, then the notch 48 may be disposed on opposite side surfaces of the rectangular cross sectional shape.

The notch 48 may include but is not limited to one of a triangular cross sectional shape perpendicular to the central axis 26, an elliptical cross sectional shape perpendicular to the central axis 26, a trapezoidal cross sectional shape perpendicular to the central axis 26, a rectangular cross sectional shape perpendicular to the central axis 26 or a semi-spherical cross sectional shape perpendicular to the central axis 26. Several different embodiments of the macro-sized locking feature 46 are shown in FIGS. 5-10. Referring to FIG. 5, a first alternative embodiment of the macro-sized locking feature is generally shown at 146 at the first end 38 of the conductor bar 36. The macro-sized locking feature 146 includes a plurality of notches 148 disposed on opposing sides of the conductor bar 36. Each of the plurality of notches 148 defines a generally triangular recess into the conductor bar 36. Referring to FIG. 6, a second alternative embodiment of the macro-sized locking feature is generally shown at 246 at the first end 38 of the conductor bar 36. The macro-sized locking feature 246 includes a single notch 248 disposed on each opposing side of the conductor bar 36. Each of the notches 248 defines a generally elongated trapezoidal recess into the conductor bar 36. Referring to FIG. 7, a third alternative embodiment of the macro-sized locking feature is generally shown at 346 at the first end 38 of the conductor bar 36. The macro-sized locking feature 346 includes a single notch 348 disposed on each opposing side of the conductor bar 36. Each of the notches 348 defines a generally elongated elliptical recess into the conductor bar 36. Referring to FIG. 8, a fourth alternative embodiment of the macro-sized locking feature is generally shown at 446 at the first end 38 of the conductor bar 36. The macro-sized locking feature 446 a plurality of notches 448 disposed on opposing sides of the conductor bar 36. Each of the plurality of notches 448 defines a generally elliptical recess into the conductor bar 36. Referring to FIG. 9, a fifth alternative embodiment of the macro-sized locking feature is generally shown at 546 at the first end 38 of the conductor bar 36. The macro-sized locking feature 546 includes a single notch 548 disposed on each opposing side of the conductor bar 36. Each of the notches 548 defines a generally elongated dovetail recess into the conductor bar 36. Referring to FIG. 10, a sixth alternative embodiment of the macro-sized locking feature is generally shown at 646 at the first end 38 of the conductor bar 36. The macro-sized locking feature 646 a plurality of notches 648 disposed on opposing sides of the conductor bar 36. Each of the plurality of notches 648 defines a dovetail recess into the conductor bar 36.

It should be appreciated that the macro-sized locking feature 46 may include some other geometric shape other than those shown in the Figures, and the scope of the claims should not be limited to the specific shapes of the macro-sized locking features 46 shown herein.

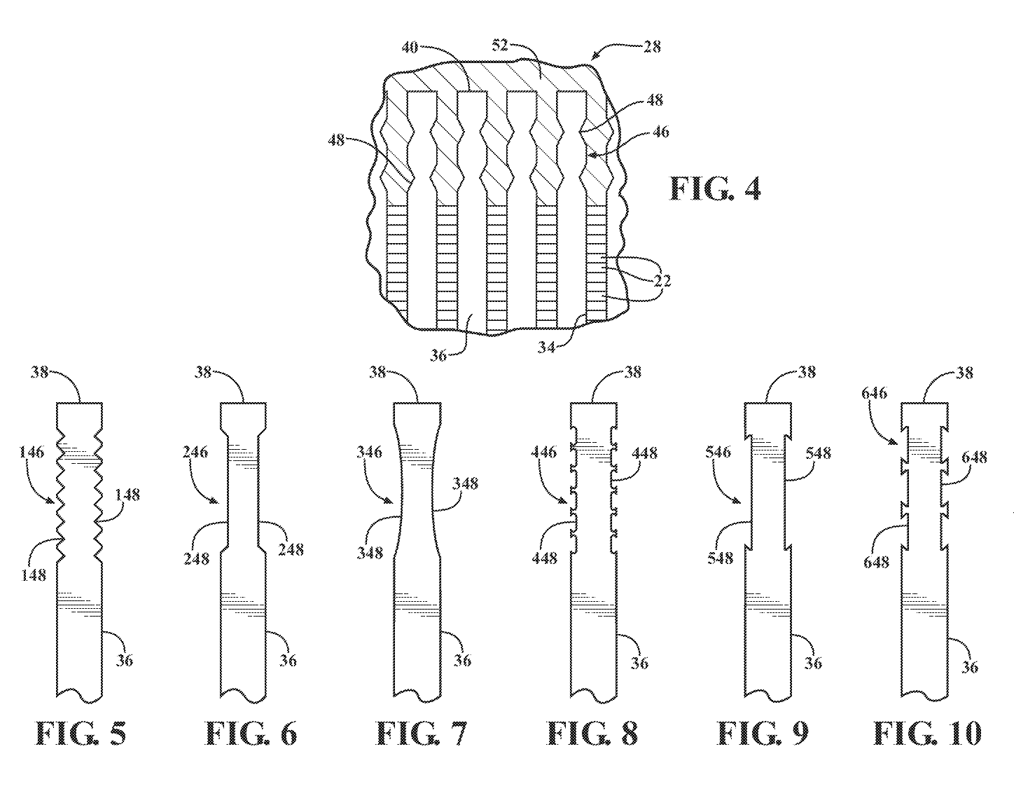

Referring to FIGS. 1 and 4, a first end ring 50 is disposed against and abuts the first end surface 30 of the laminated stack 28 of electric steel sheets 22. The first end ring 50 at least partially surrounds and electrically connects the first end 38 of each of the conductor bars 36. A second end ring 52 is disposed against and abuts the second end surface 32 of the laminated stack 28 of electric steel sheets 22. The second end ring 52 at least partially surrounds and electrically connects the second end 40 of each of the conductor bars 36.

The first end ring 50 and the second end ring 52 are each cast in place over the first ends 38 of the conductor bars 36 and the second ends 40 of the conductor bars 36 respectively. Preferably, the first end ring 50 and the second end ring 52 are cast in place from aluminum or an aluminum alloy. However, it should be appreciated that the first end ring 50 and the second end ring 52 may be cast in place from some other conductive material. The first end ring 50 and the second end ring 52 may be cast using any suitable casting process, including but not limited to a squeeze casting process, a high pressure die casting process, a low pressure die casting process or a sand casting process.

As shown in FIG. 4, the macro-sized locking feature 46 at the first end 38 of each of the conductor bars 36 mechanically interlocks with the first end ring 50. Similarly, the macro-sized locking feature 46 at the second end 40 of each of the conductor bars 36 mechanically interlocks with the second end ring 52.

The macro-sized locking feature 46 is a macro-sized geometric feature that allows the cast in place material of the first end ring 50 and the second end ring 52 to flow into the macro-sized locking feature 46 and mechanically interlock with the macro-sized locking feature 46, thereby improving the mechanical and electrical bond between the conductor bars 36 and the first end ring 50 or the second end ring 52. The minimum radius of the macro-scale macro-sized locking feature 46s may be determined by Equation 1:

$$R = \frac{2 γ}{P} \qquad ( 1 )$$

wherein R is the minimum radius of the macro-sized locking feature 46 measured in micrometers, γ is the surface tension of the liquid material used to cast the first end ring 50 and/or the second end ring 52 measured in N/m, and P is the pressure applied to the liquid material during solidification measured in Atm. The minimum radius of the macro-sized locking feature 46 is the minimum size that will allow the liquid material molding the first end ring 50 and/or the second end ring 52 to fully flow into and fill up the macro-sized locking feature 46, thereby ensuring a proper mechanical locking bond between the macro-sized locking feature 46 and the cast in place first end ring 50 and/or second end ring 52.

At one atmosphere pressure, such as with the gravity poured sand casting process, the minimum radius R of the macro-sized locking feature 46 must be larger than 18 μm. However, under higher pressure, such as at a pressure equal to 10,000 psi under the high pressure die casting process, the minimum radius R of the macro-sized locking feature 46 must be larger than only 0.027 μm.

A method of manufacturing the rotor assembly 20 is also disclosed. The method includes laminating the plurality of electric steel sheets 22 together to define the laminated stack 28. As described above, the laminated stack 28 includes the first end surface 30 and the second end surface 32. The second end surface 32 is axially spaced from the first end surface 30 along the central axis 26. The electric steel sheets 22 are laminated together in such a manner so that the slots 24 in each of the electric steel sheets 22 cooperate together to define the longitudinal grooves 34 extending along the central axis 26, between the first end surface 30 and the second end surface 32, with the grooves 34 angularly spaced about and equidistant from the central axis 26.

The method further includes molding the conductor bars 36. The conductor bars 36 are molded to include the conductor length 42 greater than the stack length 44 of the laminated stack 28 of electric steel sheets 22 so that the first end 38 and the second end 40 of each of the conductor bars 36 extend outward beyond the first end surface 30 and the second end surface 32 respectively. The conductor bars 36 are also molded to define the macro-sized locking feature 46 in the first end 38 and the second end 40 of each of the conductor bars 36. The conductor bars 36 may be molded in any suitable manner, including but not limited to casting the conductor bars 36 or shaping and cutting the conductor bars 36 using conventional metal working techniques.

The method further includes positioning one of the conductor bars 36 in each of the longitudinal grooves 34. The conductor bars 36 are positioned such that the first end 38 and the second end 40 of each of the plurality of conductor bars 36 extend outward beyond the first end surface 30 and the second end surface 32 of the laminated stack 28 respectively.

The method further includes placing the laminated stack 28 with the plurality of conductor bars 36 positioned therein in a mold. The mold defines the cavities that define the shape of the first end ring 50 and/or the second end ring 52. The mold may include any suitable shape and/or size for casting the first end ring 50 and/or the second end ring 52, and may depend upon the casting process utilized to cast the first end ring 50 and/or the second end ring 52.

The method further includes casting the first end ring 50 in place around the macro-sized locking feature 46 of the first end 38 of each of the plurality of conductor bars 36, and casting the second end ring 52 in place around the macro-sized locking feature 46 of the second end 40 of each of the plurality of conductor bars 36. The first end ring 50 and the second end ring 52 are cast to at least partially surround and electrically connect the first end 38 of each of the plurality of conductor bars 36 with the first end ring 50, and to at least partially surround and electrically connect the second end 40 of each of the plurality of conductor bars 36 with the second end ring 52.

Casting the first end ring 50 and/or the second end ring 52 includes injecting molten material into the mold and around the macro-sized locking feature 46 in the first end 38 of each of the plurality of conductor bars 36 and/or the macro-sized locking feature 46 in the second end 40 of each of the conductor bars 36. Preferably, the first end ring 50 and the second end ring 52 are cast from aluminum or an aluminum alloy. However, some other conductive material may be utilized. Casting the first end ring 50 and/or the second end ring 52 may further include flowing the molten material into and around the macro-sized locking feature 46 to mechanically interlock with the macro-sized locking feature 46 upon solidification.

Casting the first end ring 50 and/or the second end ring 52 may further include compressing the molten material as the molten material solidifies. Compressing the molten material as the molten material solidifies during the casting process reduces the porosity in the finished cast in place product, enhances the interlocking strength between the macro-sized locking features in the conductor bars and the solidified end rings, as well as improves mechanical properties of the finished product.

While the best modes for carrying out the invention have been described in detail, those familiar with the art to which this invention relates will recognize various alternative designs and embodiments for practicing the invention within the scope of the appended claims.

1. A rotor assembly for an electric device, the rotor assembly comprising:
a plurality of electric steel sheets each defining a plurality of slots disposed angularly about and equidistant from a central axis, wherein the plurality of electric steel sheets are disposed adjacent each other to define a laminated stack having a first end surface and a second end surface spaced from the first end surface along the central axis, with the plurality of slots aligned to define a plurality of longitudinal grooves in the laminated stack;
a plurality of conductor bars, with one of the plurality of conductor bars disposed within each of the plurality of longitudinal grooves, wherein each of the plurality of conductor bars includes a first end extending axially beyond the first end surface of the laminated stack along the central axis; and
a first end ring disposed against and abutting the first end surface and at least partially surrounding and electrically connecting the first end of each of the plurality of conductor bars;
wherein the first end of each of the plurality of conductor bars includes a macro-sized locking feature mechanically interlocking with the first end ring.

2. A rotor assembly as set forth in claim 1 wherein each of the plurality of conductor bars includes a second end extending axially beyond the second end surface of the laminated stack along the central axis, and further comprising a second end ring disposed against and abutting the second end surface and at least partially surrounding and electrically connecting the second end of each of the plurality of conductor bars, wherein the second end of each of the plurality of conductor bars includes a macro-sized locking feature mechanically interlocking with the second end ring.

3. A rotor assembly as set forth in claim 2 wherein the first end ring and the second end ring are each cast in place over the first end and the second end of each of the plurality of conductor bars.

4. A rotor assembly as set forth in claim 3 wherein the first end ring and the second end ring include aluminum.

5. A rotor assembly as set forth in claim 4 wherein the macro-sized locking feature includes a minimum radius R defined by the equation:
$$R = \frac{2 γ}{P}$$
wherein γ is the surface tension of a liquid material used to cast the first end ring and/or the second end ring, and P is the pressure applied to the liquid material during solidification.

6. A rotor assembly as set forth in claim 1 wherein each of the plurality of conductor bars includes a uniform cross sectional shape between the first end surface and the second end surface of the laminated stack.

7. A rotor assembly as set forth in claim 5 wherein the macro-sized locking feature includes a notch extending inward into each of the plurality of conductor bars.

8. A rotor assembly as set forth in claim 6 wherein the notch includes one of a triangular cross sectional shape perpendicular to the central axis, an elliptical cross sectional shape perpendicular to the central axis, a trapezoidal cross sectional shape perpendicular to the central axis, a rectangular cross sectional shape perpendicular to the central axis or a semi-spherical cross sectional shape perpendicular to the central axis.

9. A rotor assembly as set forth in claim 7 wherein the notch includes a plurality of notches axially spaced from each other along the central axis.

10. A rotor assembly as set forth in claim 7 wherein the notch extends circumferentially around an outer periphery of each of the plurality of conductor bars.

11. A rotor assembly as set forth in claim 7 wherein the uniform cross sectional shape of each of the conductor bars includes a rectangular shape, with the notch disposed on opposite sides of the rectangular cross sectional shape.

12. A rotor assembly for an electric device, the rotor assembly comprising:
a plurality of electric steel sheets each defining a plurality of slots disposed angularly about and equidistant from a central axis, wherein the plurality of electric steel sheets are disposed adjacent each other to define a laminated stack having a first end surface and a second end surface spaced from the first end surface along the central axis, with the plurality of slots aligned to define a plurality of longitudinal grooves in the laminated stack extending along the central axis;
a plurality of conductor bars, with one of the plurality of conductor bars disposed within each of the plurality of longitudinal grooves, wherein each of the plurality of conductor bars includes a first end extending axially beyond the first end surface of the laminated stack along the central axis, and a second end extending axially beyond the second end surface of the laminated stock along the central axis;
a first end ring disposed against and abutting the first end surface and at least partially surrounding and electrically connecting the first end of each of the plurality of conductor bars;
a second end ring disposed against and abutting the second end surface and at least partially surrounding and electrically connecting the second end of each of the plurality of conductor bars;
wherein the first end and the second end of each of the plurality of conductor bars include a macro-sized locking feature mechanically interlocking with the first end ring and the second end ring respectively, with the first end ring and the second end ring cast in place from aluminum over the first ends and the second ends of the plurality of conductor bars respectively; and
wherein the macro-sized locking feature includes a notch extending inward into each of the plurality of conductor bars.

13. A method of manufacturing a rotor assembly for an electric device, the method comprising:
molding a plurality of conductor bars to define a macro-sized locking feature in a first end and a second end of each of the plurality of conductor bars;
laminating a plurality of electric steel sheets to define a laminated stack having a first end surface and a second end surface axially spaced from the first end surface along a central axis, and a plurality of longitudinal grooves extending along the central axis between the first end surface and the second end surface, wherein the plurality of grooves are angularly spaced about and equidistant from the central axis;
positioning one of the plurality of conductor bars in each of the plurality of longitudinal grooves such that the first end and the second end of each of the plurality of conductor bars extend outward beyond the first end surface and the second end surface of the laminated stack respectively;
casting a first end ring in place around the macro-sized locking feature of the first end of each of the plurality of conductor bars to at least partially surround and electrically connect the first end of each of the plurality of conductor bars.

14. A method as set forth in claim 13 further comprising casting a second end ring in place around the macro-sized locking feature in the second end of each of the plurality of conductor bars to at least partially surround and electrically connect the second end of each of the plurality of conductor bars.

15. A method as set forth in claim 14 wherein casting the first end ring and the second end ring includes flowing molten material into and around the macro-sized locking feature to mechanically interlock with the macro-sized locking feature upon solidification.

16. A method as set forth in claim 14 wherein the first end ring and the second end ring are cast from aluminum.

17. A method as set forth in claim 14 further comprising placing the laminated stack of the electric steel plates with the plurality of conductor bars positioned therein in a mold defining a cavity for each of the first end ring and the second end ring.

18. A method as set forth in claim 17 wherein casting the first end ring and the second end ring includes injecting molten material into the mold and around the macro-sized locking feature in the first end and the second end of each of the plurality of conductor bars.

19. A method as set forth in claim 18 wherein casting the first end ring and the second end ring includes compressing the molten material as the molten material solidifies.

20. A method as set forth in claim 13 wherein casting the first end ring and the second end ring includes casting the first end ring and the second end ring with one of a high pressure die casting process, a low pressure die casting process, a sand casting process or a squeeze casting process.
